(19) United States
(12) Patent Application Publication
(10) Pub. No.: US 2018/0011446 A1
(43) Pub. Date: Jan. 11, 2018

(54) PORTABLE ELECTRONIC DEVICE

(71) Applicant: SEIKO EPSON CORPORATION, Tokyo (JP)

(72) Inventors: Mitsuto YANAGISAWA, Matsumoto-shi (JP); Junya SHIBUYA, Shiojiri-shi (JP); Yukiho HAMANO, Chino-shi (JP)

(73) Assignee: SEIKO EPSON CORPORATION, Tokyo (JP)

(21) Appl. No.: 15/640,898

(22) Filed: Jul. 3, 2017

(30) Foreign Application Priority Data
Jul. 7, 2016 (JP) 2016-134815

(51) Int. Cl. G04B 43/00; G04G 9/00; G04B 19/22

(52) U.S. Cl. CPC G04B 43/002; G04B 19/223; G04G 9/00

(57) ABSTRACT

A portable electronic device includes: a case (top case); a bezel having a ring shape located on the outer edge side of the case and attached to the case; and a windshield plate located inside the bezel. The bezel includes a first member (bezel main body portion) having a ring shape fitted to the case and a second member (bezel display plate) softer than the first member and holding the windshield plate.

### CROSS-REFERENCE TO RELATED APPLICATION

This application claims priority of Japanese Patent Application No. 2016-134815, filed Jul. 7, 2016, which is expressly incorporated herein by reference in its entirety.

### BACKGROUND

### 1. Technical Field

The present invention relates to a portable electronic device.

### 2. Related Art

In recent years, many wrist watch-type activity meters (one example of portable electronic devices) have been commercialized by manufacturers with improved sensing technology. An example of a wrist watch-type activity meter is a GPS device that is worn on a site (subject) such as the wrist with a belt or the like, and can display position information using, for example, a GPS (Global Positioning System) (e.g., see U.S. Pat. No. 9257740).

Moreover, in the wrist watch-type activity meter (one example of portable electronic devices), a structure is known that includes a bezel holding a windshield plate. This structure expands the number of design variations of such a meter, and can increase the decorativeness and improve the designability thereof (e.g., see JP-A-2007-132876).

The bezel of the wrist watch-type activity meter (portable electronic device) described above needs to have predetermined rigidity for holding the windshield plate. However, when the rigidity is increased using, for example, metal, an external impact or the like received by the case or the bezel is likely to be transmitted to the windshield plate and thus may cause damage to the windshield plate.

### SUMMARY

An advantage of some aspects of the invention is to solve at least a part of the problems described above, and the invention can be implemented as the following forms or application examples.

### Application Example 1

A portable electronic device according to this application example includes: a case; and a ring-shaped bezel attached to the case. The bezel includes a first member and a second member. The first member has a ring shape and front and back surfaces. The back surface of the first member is fitted to the case. The second member is composed of a material of lower hardness than the first member and is supported by the front surface of the first member. The device also includes a windshield plate supported by the second member.

According to this application example, the second member softer than the first member holds the windshield plate. With this configuration, an impact transmitted from the case side to the windshield plate through the bezel is absorbed by the softness of the second member disposed between the windshield plate and the case, and thus damage caused to the windshield plate can be reduced. Moreover, the strength of the bezel can be secured with the first member constituting the bezel, so that it is possible to hold the windshield plate while buffering the impact.

### Application Example 2

In the portable electronic device according to the application example, it is preferable that a longitudinal modulus of elasticity of the second member is smaller than a longitudinal modulus of elasticity of the first member, or a shear modulus of elasticity of the second member is smaller than a shear modulus of elasticity of the first member.

According to this application example, the impact transmitted from the case side to the windshield plate through the bezel is attenuated (buffered) due to viscoelastic loss caused by distorting the second member disposed between the windshield plate and the case, so that it is possible to suppress damage caused to the windshield plate.

### Application Example 3

In the portable electronic device according to the application example, it is preferable that the second member is made of a resin.

According to this application example, the second member made of, for example, a resin can be molded and cured by ultraviolet rays or the like. The molding of the second member can be easily performed as described above, and it is also possible to easily respond to the diversification of designs.

### Application Example 4

In the portable electronic device according to the application example, it is preferable that the second member has a light transmissive property, a back surface facing the case, and a display mark on the back surface.

The bezel is disposed at the outer edge portion of the case close to the front surface. Therefore, when the portable electronic device is worn by the user, the bezel is likely to hit or rub against an external object and thus is often scratched. According to this application example, however, the display mark of the bezel is provided on the surface of the second member on the case side, that is, on the side not exposed in the front surface. Therefore, even if the bezel is damaged for example, the disappearance or falling off of the display mark can be reduced.

### Application Example 5

In the portable electronic device according to the application example, it is preferable that the display mark includes at least one of a character, a symbol, a scale, and a pattern.

According to this application example, in the bezel having a ring shape disposed in a region on the outer edge side of a display unit, a character, a symbol, a scale, a pattern, and the like, which are functionally useful, can be provided, and designability can be improved such as, for example, changing the color or color tone.

### Application Example 6

In the portable electronic device according to the application example, it is preferable that the second member includes an eaves portion protruding beyond the first member in a radial direction of the first member to contact the windshield plate.

According to this application example, the windshield plate and the second member can reliably abut on each other with the eaves portion protruding to the windshield plate side. In other words, since the eaves portion is provided, the windshield plate can be prevented from contacting other constituting portions.

### Application Example 7

In the portable electronic device according to the application example, it is preferable that the case has a front side facing the back surface of the first member and includes a recessed portion sized to accommodate at least a portion of the first member therein. The at least a portion of the first member is disposed in the recessed portion.

According to this application example, the first member can be easily arranged by inserting the first member into the recessed portion, and the alignment of the bezel (first member) with the case can be easily performed.

### Application Example 8

In the portable electronic device according to the application example, it is preferable that the device further include a display and a light source. The display has front and back surfaces and is supported by the case. The front surface of the display faces the windshield plate. The light source is supported by the case and is disposed behind the back surface of the display to irradiate the back surface of the display with light. The first member is provided with a light guide hole extending between the back surface and the front surface of the first member, and the light emitted from the light source is transmitted to the second member through the light guide hole.

According to this application example, the second member or the display mark of the second member glows brightly as viewed from the windshield plate side because the light of the light source radiated to the second member through the light guide hole passes through the second member having a light transmissive property. Therefore, the visibility of the display mark can be improved even in a dark state.

### Application Example 9

In the portable electronic device according to the application example, it is preferable that the device further includes a ring-shaped third member abutting an outer edge of the windshield plate and disposed between the windshield plate and the display. A longitudinal modulus of elasticity of the third member is smaller than a longitudinal modulus of elasticity of the windshield plate and the display, or a shear modulus of elasticity of the third member is smaller than a shear modulus of elasticity of the windshield plate and the display.

According to this application example, stress occurring between the windshield plate and the display unit is attenuated (buffered) due to viscoelastic loss caused by distorting the third member disposed between the windshield plate and the display unit, so that it is possible to suppress damage caused by the stress of the windshield plate and the display unit.

### Application Example 10

In the portable electronic device according to the application example, it is preferable that the third member is made of a resin.

According to this application example, the third member made of, for example, a resin can be molded and cured by ultraviolet rays or the like. Therefore, the molding of the third member can be easily performed, and it is also possible to easily respond to the diversification of designs.

### Application Example 11

In the portable electronic device according to the application example, it is preferable that the windshield plate has a front surface, and the third member includes the display mark visually recognizable from the front surface of the windshield plate.

According to this application example, since the third member is provided with the display mark, a character, a symbol, a scale, a pattern, and the like, which are functionally useful, can be provided, and, for example, designability can be improved such as changing the color tone.

### Application Example 12

In the portable electronic device according to the application example, it is preferable that the display includes an overlapping region that overlaps the third member in a plan view. The overlapping region of the display and the third member have a light transmissive property, and the light emitted from the light source irradiates the third member through the overlapping region.

According to this application example, the third member or the display mark of the third member glows brightly as viewed from the windshield plate side because the light of the light source radiated to the third member through the region of the display unit overlapping the third member passes through the third member having a light transmissive property. Therefore, the visibility of the display mark can be improved even in a dark state.

### Application Example 13

In the portable electronic device according to the application example, it is preferable that a longitudinal modulus of elasticity of the second member is smaller than a longitudinal modulus of elasticity of the first member, and a shear modulus of elasticity of the second member is smaller than a shear modulus of elasticity of the first member.

### Application Example 14

In the portable electronic device according to the application example, it is preferable that the device further include a ring-shaped third member abutting an outer edge of the windshield plate and disposed between the windshield plate and the display. A longitudinal modulus of elasticity of the third member is smaller than a longitudinal modulus of elasticity of the windshield plate and the display unit, and a shear modulus of elasticity of the third member is smaller than a shear modulus of elasticity of the windshield plate and the display.

### Application Example 15

In a ring-shaped bezel for holding a windshield plate of a case of a portable electronic device according to the application example, the bezel includes ring-shaped first and second members. The first member has front and back surfaces. The back surface of the first member is fitted to the case. The front surface includes a recessed portion. The second member is composed of a material of lower hardness than the first member, is disposed in the recessed portion of the first member, and holds the windshield plate.

### Application Example 16

In the ring-shaped bezel according to the application example, it is preferable that the recessed portion includes an outer-circumferential wall portion, and one end of the second member abuts the outer-circumferential wall portion.

### Application Example 17

In the ring-shaped bezel according to the application example, it is preferable that a longitudinal modulus of elasticity of the second member is smaller than a longitudinal modulus of elasticity of the first member, or a shear modulus of elasticity of the second member is smaller than a shear modulus of elasticity of the first member.

### Application Example 18

In the ring-shaped bezel according to the application example, it is preferable that a longitudinal modulus of elasticity of the second member is smaller than a longitudinal modulus of elasticity of the first member, and a shear modulus of elasticity of the second member is smaller than a shear modulus of elasticity of the first member.

### Application Example 19

In the ring-shaped bezel according to the application example, it is preferable that the second member is made of a resin.

### Application Example 20

In the ring-shaped bezel according to the application example, it is preferable that the second member has a light transmissive property, a back surface facing the case, and a display mark on the back surface that includes at least one of a character, a symbol, a scale, and a pattern.

### Application Example 21

In the ring-shaped bezel according to the application example, it is preferable that the second member includes an eaves portion protruding beyond the first member in a radial direction of the first member to contact the windshield plate.

### Application Example 22

In the ring-shaped bezel according to the application example, it is preferable that the first member is provided with a light guide hole extending between the back surface and the front surface thereof, and light emitted from a light source disposed inside the case behind a display is transmitted to the second member through the light guide hole.

### Application Example 23

In the ring-shaped bezel according to the application example, it is preferable that the bezel further include a ring-shaped third member abutting an outer edge of the windshield plate and disposed between the windshield plate and the display. A longitudinal modulus of elasticity of the third member is smaller than a longitudinal modulus of elasticity of the windshield plate and the display, or a shear modulus of elasticity of the third member is smaller than a shear modulus of elasticity of the windshield plate and the display.

### Application Example 24

In the ring-shaped bezel according to the application example, it is preferable that the third member is made of a resin, has a light transmissive property, and includes a display mark visually recognizable from a front surface of the windshield plate.

### BRIEF DESCRIPTION OF THE DRAWINGS

The invention will be described with reference to the accompanying drawings, wherein like numbers reference like elements.

FIG. 1 is a perspective view of the front surface side of a wrist device according to a first embodiment of a portable electronic device.

FIG. 2 is a plan view of the wrist device according to the first embodiment.

FIG. 3 is an exploded perspective view showing a schematic configuration of the wrist device according to the first embodiment.

FIG. 4 is a partial cross-sectional view along a cross-section A-A in FIG. 2.

FIG. 5A is a diagram as viewed from P in FIG. 5B, showing a display example of a bezel display plate of the wrist device according to the first embodiment.

FIG. 5B is a cross-sectional view taken along line B-B in FIG. 5A, showing the bezel display plate.

FIG. 6A is a plan view showing a bezel of the wrist device according to the first embodiment.

FIG. 6B is a plan view showing a modified example of the bezel.

FIG. 7A is a diagram as viewed from Q in FIG. 7B, showing a display example of a parting plate as a third member.

FIG. 7B is a cross-sectional view taken along line C-C in FIG. 7A, showing the parting plate.

FIG. 8 is a partial cross-sectional view of a wrist device according to a second embodiment of the portable electronic device.

FIG. 9 is a partial cross-sectional view of a wrist device according to a third embodiment of the portable electronic device.

FIG. 10A is a plan view of a wrist device showing a display example of Application 1.

FIG. 10B is a plan view showing a display state changed from that of FIG. 10A in Application 1.

FIG. 11A is a plan view of a wrist device showing a display example of Application 2.

FIG. 11B is a plan view showing a display state changed from that of FIG. 11A in Application 2.

FIG. 12A is a plan view of a wrist device showing a display example of Application 3.

FIG. 12B is a plan view showing a display state changed from that of FIG. 12A in Application 3.

FIG. 13A is a plan view of a wrist device showing a display example of Application 4.

FIG. 13B is a plan view showing a display state changed from that of FIG. 13A in Application 4.

FIG. 14A is a plan view of a wrist device showing a display example of Application 5.

FIG. 14B is a plan view showing a display state changed from that of FIG. 14A in Application 5.

FIG. 15A is a plan view of a wrist device showing a display example of Application 6.

FIG. 15B is a plan view showing a display state changed from that of FIG. 15A in Application 6.

### DESCRIPTION OF EXEMPLARY EMBODIMENTS

Hereinafter, embodiments will be described. The embodiments described below do not unduly limit the details of the invention set forth in the appended claims. Moreover, not all of the configurations described in the embodiments are indispensable configuration requirements of the invention.

### First Embodiment

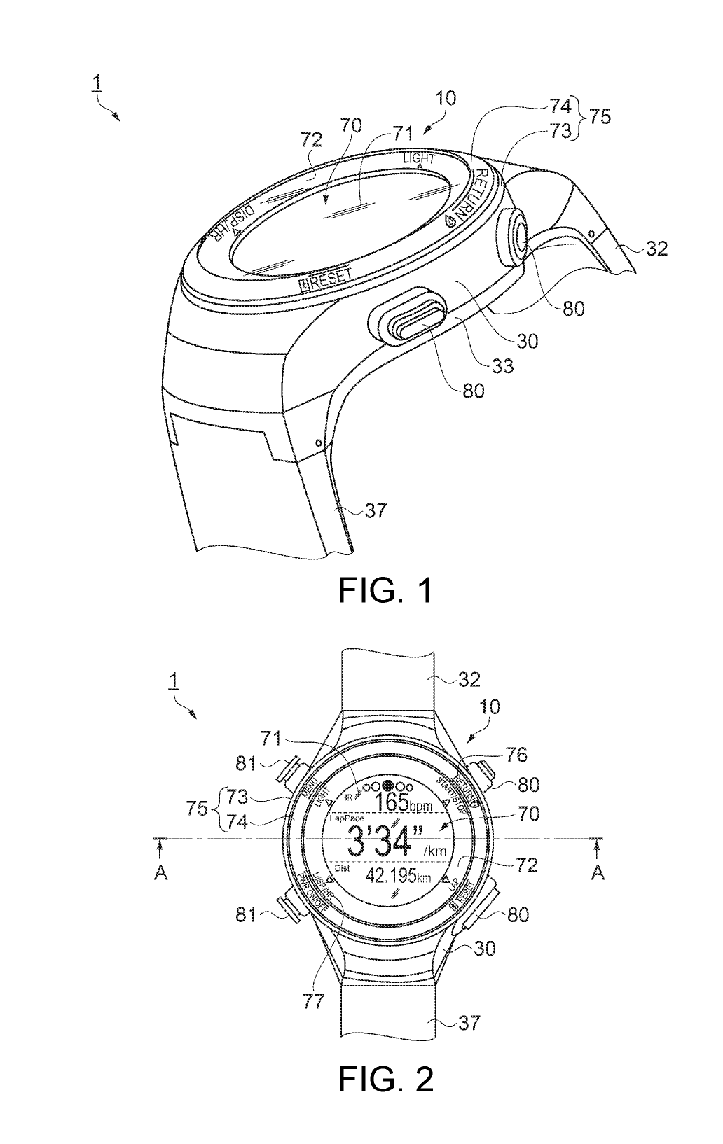

First, an overview of a wrist device according to a first embodiment of a portable electronic device according to the invention will be described with reference to FIGS. 1 and 2. FIG. 1 is a perspective view of the front surface side of the wrist device according to the first embodiment of the portable electronic device. FIG. 2 is a plan view of the wrist device according to the first embodiment. In the specification, the display surface side of the wrist device may be described as the front (front side) while the side thereof (the side in contact with the user when the user wears the wrist device) opposite to the display surface may be described as the back (back side) for convenience of description in the first to third embodiments and modified examples (applications).

As shown in FIGS. 1 and 2, the wrist device 1 as one example of the portable (wearable) electronic device is worn on a given site (e.g., the wrist) of the user (wearer), and can detect position information or exercise information of the user. The wrist device 1 includes a device main body 10 that is worn by the user and detects position information, exercise information, or the like, and a first belt portion 32 and a second belt portion 37 that are attached to the device main body 10 and used for wearing the device main body 10 by the user. The wrist device 1 can be provided with the function of, for example, detecting biological information such as pulse wave information and the function of obtaining time-of-day information or the like, in addition to the position information or exercise information of the user.

In the device main body 10, a bottom case 33 is disposed on the side to be worn on the user, and a top case 30 is disposed on the side opposite to the side to be worn on the user. A bezel 75 is provided on the front side (the top case 30) of the device main body 10, and a windshield plate (glass plate in the example) 71 as a top portion (external wall) that is disposed to be arranged with the bezel 75 and protects the internal structure is provided inside the bezel 75. A plurality of operating buttons 80 and 81 are provided on the side surface of the device main body 10 on the front side (the top case 30). The bezel 75 of the embodiment includes a bezel main body portion 73 as a first member and a bezel display plate 74 as a second member. The bezel display plate 74 may be provided with a display that can be visually recognized from the front side, and a bezel display portion 76 is disposed as one example of the display in the embodiment.

The device main body 10 may be configured such that the user can view, through the windshield plate 71, a display of a display unit 70 composed of a liquid crystal display (LCD) or the like provided directly below the windshield plate 71, or a display (e.g., a functional mark 77) of a parting plate 72 as a third member provided between the windshield plate 71 at the outer edge portion of the windshield plate 71 and the display unit 70. That is, the wrist device 1 of the embodiment may display various kinds of information such as the detected position information or exercise information, or the time-of-day information on the display unit 70, and present the display from the top side of the device main body 10 to the user. A pair of belt attaching portions (not shown) that are connection portions to the first belt portion 32 and the second belt portion 37 are provided on both sides of the bottom case 33.

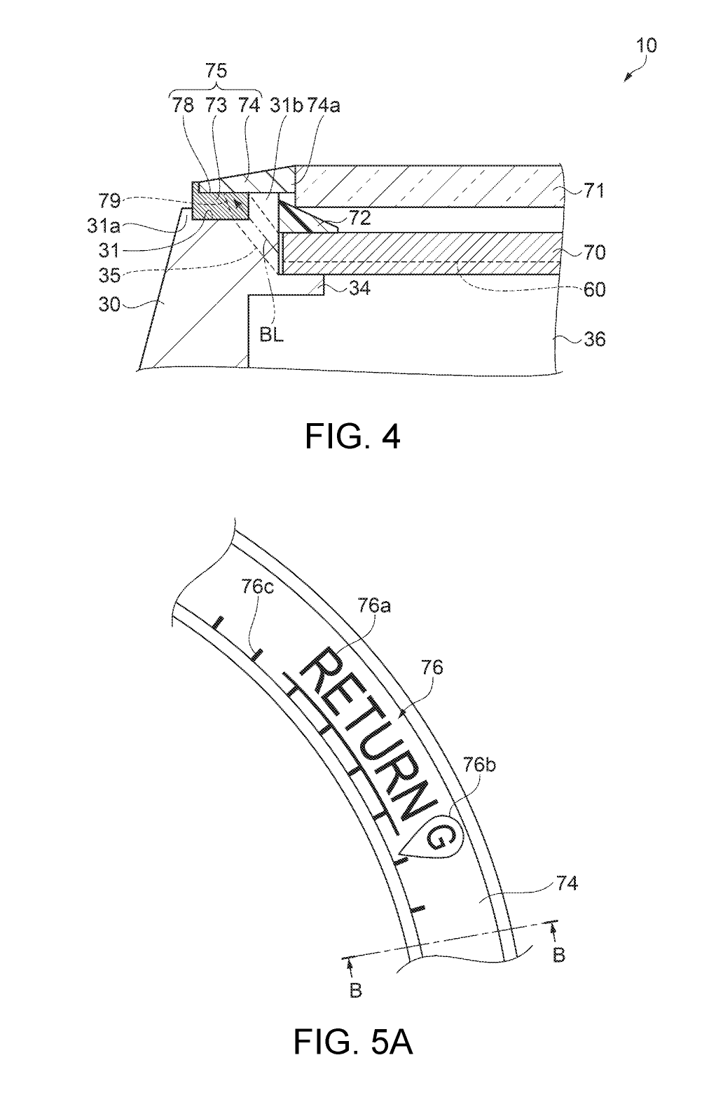

The windshield plate 71 at the top portion of the device main body 10 is not limited to a glass plate but may be a material other than glass, such as a transparent plastic, as long as the material is a transparent member through which the display unit 70 can be viewed and which is a member having a strength to such an extent that can protect the configurations, such as the liquid crystal display (LCD) constituting the display unit 70, contained in the interior (an interior space 36 shown in FIG. 4) formed of the top case 30 and the bottom case 33.

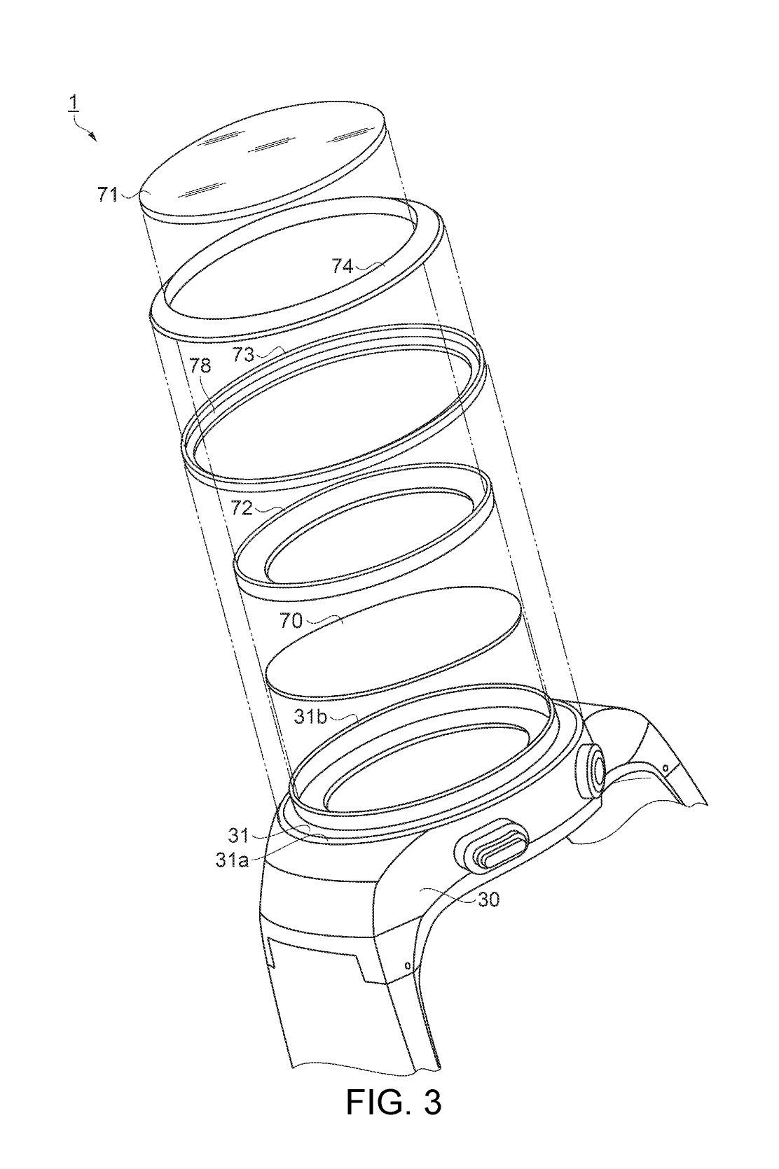

Next, a configuration example of the cross-sectional structure of the device main body 10 of the wrist device 1 will be described with reference to FIGS. 3 and 4. FIG. 3 is an exploded perspective view showing a schematic configuration of the wrist device according to the first embodiment. FIG. 4 is a partial cross-sectional view along a cross-section A-A in FIG. 2, showing a schematic configuration of the wrist device according to the first embodiment.

As shown in FIG. 4, the device main body 10 is provided with the interior space 36 surrounded by the top case 30, the bottom case 33 (see FIG. 1), and the windshield plate 71. The display unit 70 and a light source 60 are disposed in the interior space 36. Although not shown in the drawing, for example a circuit board, a GPS (Global Positioning System) antenna, a sensor component such as a barometric pressure sensor or a geomagnetic sensor, a secondary battery, and the like, which are element components constituting the wrist device 1, are accommodated in the interior space 36.

As shown in FIGS. 3 and 4, the display unit 70 is placed on a projecting portion 34 projecting to the inside of the top case 30 in the device main body 10. The parting plate 72 having a ring shape is placed along a second wall portion 31b of the top case 30 on the front side of the display unit 70. The light source 60 including the function as a backlight of the display unit 70 is disposed on the back side of the display unit 70.

For example, position information using a GPS or a geomagnetic sensor, exercise information such as the amount of exercise using the amount of movement, an angular velocity sensor, or an acceleration sensor, biological information such as a pulse rate using a pulse wave sensor, or the time-of-day information such as the current time is displayed according to various detection modes on the liquid crystal display (LCD) constituting the display unit 70. The user can view (visually recognize) this display through the windshield plate 71.

Moreover, the device main body 10 includes a recessed portion 31 having an annular shape located on the outer edge side of the top case 30 and opened toward the front side. A wall portion is configured on the outer circumferential side and the inner circumferential side of the recessed portion 31. The wall portion includes a first wall portion 31a provided on the outer circumferential side and the second wall portion 31b provided on the inner circumferential side. At least a portion of the bezel main body portion 73 (the bezel 75) as the first member is inserted into and fixed to the recessed portion 31. By inserting the bezel main body portion 73 (the bezel 75) into the recessed portion 31 as described above, alignment of the bezel main body portion 73 (the bezel 75) with the top case 30 can be easily performed. A light guide hole 35 penetrating the top case 30 from the position facing the display unit 70 or the light source 60 to the surface including the recessed portion 31 as the bezel main body portion 73 side is provided on the outer edge side of the top case 30.

A bezel recessed portion 78 including a wall portion on the outer circumferential side is provided on the front side of the bezel main body portion 73.

The bezel display plate 74 having a ring shape as the second member is placed on the bezel recessed portion 78 in the state where one end of the bezel display plate 74 abuts on the wall portion. Moreover, the bezel main body portion 73 is provided with a light guide hole 79 penetrating the bezel main body portion 73 from the position facing the light guide hole 35 provided on the outer edge side of the top case 30 to the bezel recessed portion 78. Light BL emitted from the light source 60 including the function as the backlight of the display unit 70 can be radiated to the bezel display plate 74 through the light guide hole 35 provided on the outer edge side of the top case 30 and the light guide hole 79 provided in the bezel main body portion 73.

The bezel display plate 74 attached to the bezel main body portion 73 includes an eaves portion 74a protruding from the bezel main body portion 73 side to the windshield plate 71 side. The eaves portion 74a of the bezel display plate 74 may abut on the top of the second wall portion 31b on the inner circumferential side of the top case 30. The bezel display plate 74 is configured of a material softer than the bezel main body portion 73. However, sagging of the eaves portion 74a due to gravity can be reduced because the eaves portion 74a of the bezel display plate 74 abuts on the top of the second wall portion 31b of the top case 30 described above, in addition to the bezel main body portion 73. Moreover, it is preferable that the bezel display plate 74 is configured of a material having elasticity such that at least any of a longitudinal modulus of elasticity (Young's modulus E) and a shear modulus of elasticity (rigidity modulus G) is small.

The windshield plate 71 is disposed on the inner circumferential surface (inside surface) side of the eaves portion 74a of the bezel display plate 74 protruding from the bezel main body portion 73. The windshield plate 71 is disposed such that the windshield plate 71 abuts on the inside surface of the eaves portion 74a of the bezel display plate 74 and that the outer edge portion of the windshield plate 71 on the back surface side abuts on the parting plate 72, and the windshield plate 71 is connected to the bezel display plate 74. In other words, the parting plate 72 is disposed on the outer edge side (outer edge side of the display unit 70) of the windshield plate 71 between the windshield plate 71 and the display unit 70.

Since the windshield plate 71 has to be held by the bezel 75 so as not to fall off from the device main body 10 (the top case 30) as described above, the bezel 75 needs to have rigidity (strength) to be able to withstand this holding force. However, if the rigidity (strength) of the bezel 75 is too high, an impact that the top case 30 or the bezel 75 receives from the outside or the like is likely to be transmitted as it is to the windshield plate 71. Therefore, this impact may cause damage such as breakage or crack to the windshield plate 71 configured of a breakable glass having a thin plate-shape.

In order to deal with these situations, in the embodiment, the bezel 75 is configured of a configuration in which the bezel main body portion 73 having rigidity and the bezel display plate 74 softer in hardness than the bezel main body portion 73, in other words, having elasticity overlap and are connected to each other as shown in FIG. 4. Moreover, it is preferable that the bezel display plate 74 has at least any of a longitudinal modulus of elasticity (Young's modulus E) and a shear modulus of elasticity (rigidity modulus G) that are smaller than those of the bezel main body portion 73.

The longitudinal modulus of elasticity (Young's modulus E) is easily measured by a tensile test of the material, whereas the shear modulus of elasticity (rigidity modulus G) is a value that is hard to be directly measured. However, there is the relation of Equation (1), shown below, between the Young's modulus E and the Poisson's ratio v, and the shear modulus of elasticity (rigidity modulus G) can be obtained by Equation (1).

Shear modulus of elasticity (G=[E/{2(1+v)}]) (1)

In the bezel 75 described above, a configuration obtained by subjecting a metal surface of, for example, a brass material, a stainless steel material, or the like to a plating process is used for the bezel main body portion 73. Here, the longitudinal modulus of elasticity (Young's modulus E) of the exemplified brass material is 110 (GPa), and the shear modulus of elasticity (rigidity modulus G) thereof is 41 (GPa). Moreover, the longitudinal modulus of elasticity (Young's modulus E) of the stainless steel material is approximately from 200 to 210 (GPa), and the shear modulus of elasticity (rigidity modulus G) thereof is approximately from 77 to 84 (GPa).

For the bezel display plate 74, an ultraviolet-curable resin material (member made of a resin) such as, for example, urethane acrylate, acrylic resin acrylate, or epoxy acrylate is used. The cured resin material described above has a light transmitting property (is transparent) and can transmit light. The longitudinal modulus of elasticity (Young's modulus E) of such a resin material, for example urethane acrylate, is approximately 0.8 (GPa), and the Poisson's ratio v thereof is 0.35. That is, G =0.30 (GPa) is obtained from Equation (1) (G=[E/{2(1+v)}]) for the shear modulus of elasticity (rigidity modulus G) of the resin material constituting the bezel display plate 74 as the second member. For example, the longitudinal modulus of elasticity (Young's modulus E) of acrylic resin acrylate is approximately 3.2 (GPa), and the Poisson's ratio v thereof is 0.35. That is, G =1.19 (GPa) is obtained from Equation (1) (G=[E/{2(1+v)}]) for the shear modulus of elasticity (rigidity modulus G) of the resin material constituting the bezel display plate 74 as the second member. As described above, the relation in which the longitudinal modulus of elasticity (Young's modulus E) and the shear modulus of elasticity of the bezel display plate 74 as the second member are smaller than the longitudinal modulus of elasticity (Young's modulus E) and the shear modulus of elasticity (rigidity modulus G) of the bezel main body portion 73 as the first member is sufficiently satisfied.

By employing the bezel display plate 74 made of a resin as described above, the bezel display plate 74 can be molded and cured by, for example, ultraviolet rays or the like. Therefore, the molding of the bezel display plate 74 can be easily performed, and it is possible to easily respond to the diversification of designs.

Moreover, the bezel display plate 74 as the second member having a longitudinal modulus of elasticity and a shear modulus of elasticity that are smaller than those of the bezel main body portion 73 as the first member abuts on the windshield plate 71 as described above. With this configuration, the impact transmitted from the case (the top case 30) side to the windshield plate 71 through the bezel 75 is attenuated (buffered) due to viscoelastic loss caused by distorting the bezel display plate 74 disposed between the windshield plate 71 and the case, so that it is possible to suppress damage that may be caused to the windshield plate 71. Moreover, the strength (rigidity) of the bezel 75 can be secured with the bezel main body portion 73 constituting the bezel 75, so that it is possible to reliably hold the windshield plate 71 to the case (the top case 30) while buffering the impact.

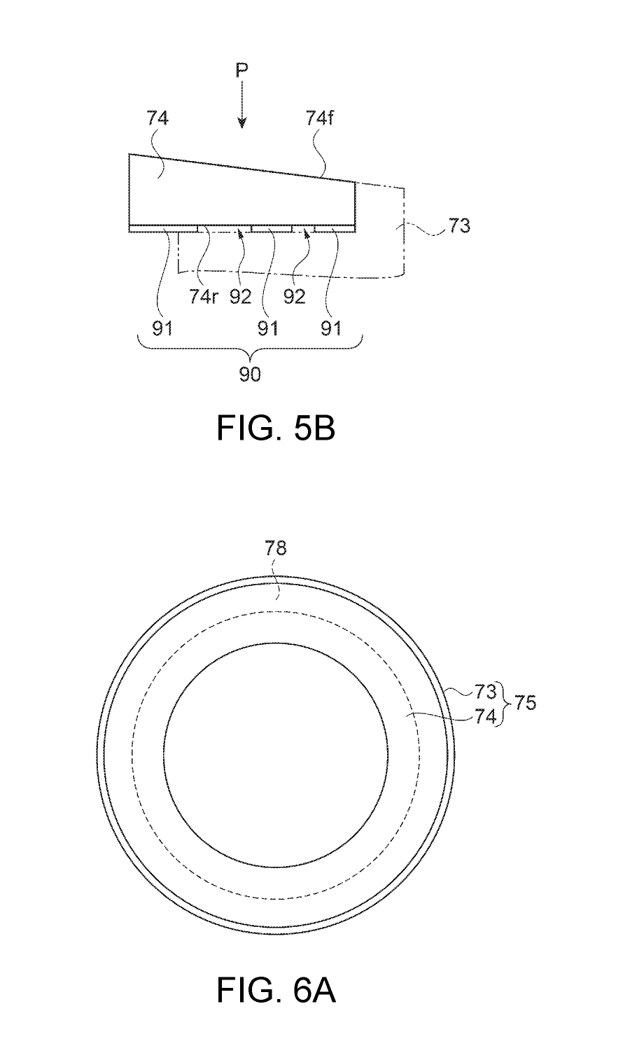

The decorativeness of the bezel 75 (the bezel display plate 74), such as a metal texture or an appearance of solidity, is enhanced, or a function display or a decoration display such as fine characters, marks, scales, or patterns may be performed on the bezel 75 (the bezel display plate 74). Here, a display of the bezel display plate 74 will be described with reference to FIGS. 5A and 5B. FIG. 5A shows a display example of the bezel display plate of the wrist device according to the first embodiment, is a diagram of a portion of the bezel display plate as viewed from the front side, and is a diagram (partial diagram) viewed from P in FIG. 5B. FIG. 5B is a cross-sectional view taken along line B-B in FIG. 5A, showing the bezel display plate.

As shown in FIGS. 5A and 5B, a bezel display portion 76 as a display mark is provided on a back surface 74r that is a surface (surface on the top case 30 side) of the bezel display plate 74 on the bezel main body portion 73 side. The bezel display portion 76 can be provided with, for example, a character 76a, a symbol (pictogram) 76b, a scale 76c, and the like. It is sufficient that the bezel display portion 76 is provided with at least one of the character 76a, the symbol (pictogram) 76b, and the scale 76c. Moreover, a color tone may be changed or a pattern may be formed in the bezel display portion 76 to enhance designability. Since the bezel display plate 74 is made of the resin having a light transmissive property as described above, the bezel display portion 76 can be visually recognized from a front surface 74f side even when the bezel display portion 76 is provided on the back surface 74r side.

The bezel display portion 76 can be configured of a display pattern 90 representing the character 76a or the symbol 76b formed using, for example, a back side printing (drawing) method or the like of a screen printing device, an inkjet printer, or the like. The bezel display portion 76 (the display pattern 90) can also be formed using an etching method. The display pattern 90 includes a light shielding portion 91 or a translucent portion (not shown) formed of, for example, ink or the like and a light transmissive portion 92 where the light shielding portion 91 or the translucent portion (not shown) is not formed. A pattern or color design can be expressed in the light shielding portion 91 or the translucent portion (not shown) by changing the color or color tone of ink.

Since the bezel 75 (the bezel display plate 74) is disposed exposed at the outer edge portion of the top case 30 close to the front surface, the bezel 75 (the bezel display plate 74) is likely to hit or rub against an external object when the wrist device is worn by the user (wearer), and it is possible to prevent difficulty in reading the character 76a, the symbol (pictogram) 76b, the scale 76c, and the like due to a hollow, a scratch, or the like caused by hitting or rubbing.

Moreover, in the bezel 75 having a ring shape disposed in a region on the outer edge side of the display unit 70, the character 76a, the symbol 76b, the scale 76c, a pattern (not shown), and the like, which are functionally useful, can be provided, and designability can be improved such as, for example, changing the color or color tone.

As shown in FIG. 1, the bezel 75 is disposed at the outer edge portion of the top case 30 on the front surface side of the device main body 10; therefore, when the wrist device is worn by the user, the bezel 75 is likely to hit or rub against an external site and thus is often scratched.

To deal with this as in the embodiment, the bezel display portion 76 as a display mark is provided as a back side printing on the back surface 74r, which is the surface of the bezel display plate 74 on the bezel main body portion 73 side (the top case 30 side), that is, on the surface not exposed on the front surface 74f side. Hence, even when the exposed front surface 74f of the bezel 75 (the bezel display plate 74) suffers damage such as a scratch or a hollow, the disappearance or falling off of the display mark can be reduced. The ultraviolet-curable resin material (member made of a resin), such as, for example, urethane acrylate, acrylic resin acrylate, or epoxy acrylate, constituting the bezel display plate 74 described in the embodiment has favorable scratch resistance, and a scratch or hollow of the front surface 74f is less likely to occur.

Although FIG. 4 shows an example in which the front-side surface of the bezel display plate 74 constituting the bezel 75 and the front-side surface of the windshield plate 71 constitute the same plane, the surfaces may not necessarily constitute the same plane. For example, an example in which the front-side surface of the windshield plate 71 projects from the front-side surface of the bezel display plate 74 may be employed, or an example in which the front-side surface of the windshield plate 71 is recessed from the front-side surface of the bezel display plate 74 may be employed. Moreover, the front-side surface of the bezel display plate 74 and the front-side surface of the windshield plate 71 each may be a plane or a so-called spherical surface having an arc-like bulge.

Moreover, the bezel main body portion 73 is provided with the light guide hole 79 penetrating the bezel main body portion 73 from the interior space 36 side (the light source 60 side) to the bottom surface (the side of the parting plate 72 as the second member) of the bezel recessed portion 78. Further, also the top case 30 at the position facing the light guide hole 79 is provided with the light guide hole 35 penetrating the top case 30 from the bezel main body portion 73 side to the interior space 36 side. The light source 60 is disposed on the interior space 36 side of the light guide hole 35. The light BL emitted from the light source 60 is radiated to the bezel display plate 74 through the light guide hole 35 and the light guide hole 79.

The bezel display plate 74 is made of the resin having a light transmissive property. Therefore, when the light BL emitted from the light source 60 is radiated to the bezel display plate 74 through the light guide hole 35 and the light guide hole 79, the light BL passes (transmits) through the light transmissive portion 92 or the translucent portion (not shown). Moreover, the radiated light BL is blocked at the portion of the light shielding portion 91. Hence, when the bezel display plate 74 is viewed from the front surface side of the device main body 10, the passing light (the light BL) can be visually recognized only in the portion of the light transmissive portion 92 or the translucent portion, and thus the contrast between the light transmissive portion 92 or the translucent portion and the light shielding portion 91 not transmitting the light BL is brought out.

The translucent portion (not shown) has a small amount of transmitted light compared to the light transmissive portion 92, and therefore glows slightly darker than the light transmissive portion 92. Moreover, since the display mark configured of the light transmissive portion 92 or the translucent portion glows brightly with the light BL of the light source 60, the display mark can be visually recognized even in a dark state. As described above, the visibility of the display mark in the dark can be improved. Moreover, an improvement in designability such as, for example, changing the color or color tone can also be achieved.

In the display pattern 90, the portions of the character 76a, the symbol 76b, and the scale 76c can be the light transmissive portions 92 or the light shielding portions 91. That is, the character 76a, the symbol 76b, and the scale 76c glow when the character 76a, the symbol 76b, and the scale 76c are the light transmissive portions 92; while portions other than the character 76a, the symbol 76b, and the scale 76c glow when the character 76a, the symbol 76b, and the scale 76c are the light shielding portions 91.

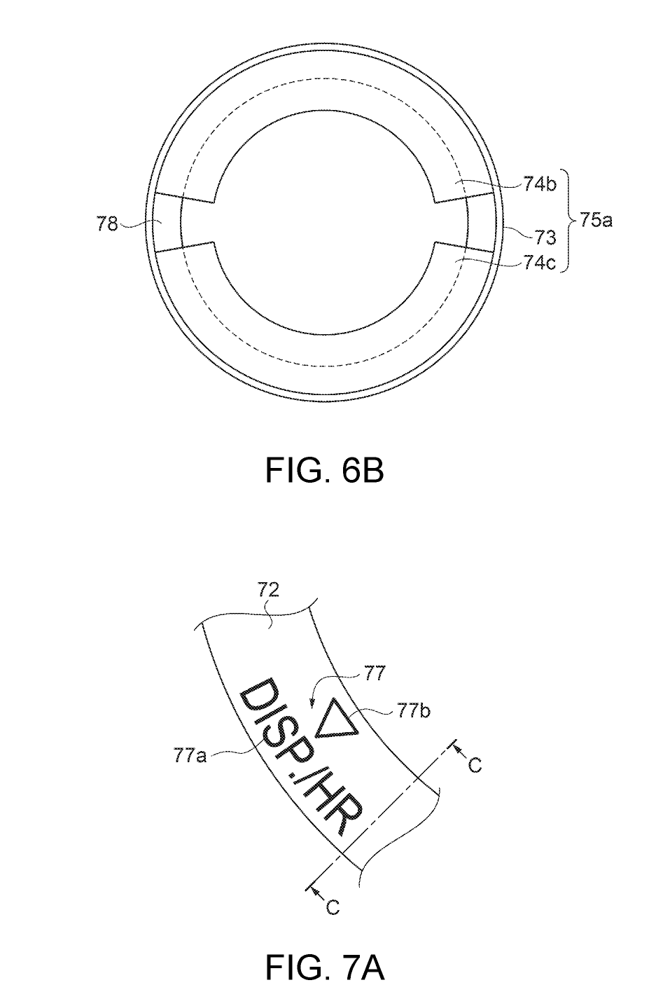

As shown in FIG. 6A, in the bezel 75 according to the first embodiment described above, the bezel main body portion 73 and the bezel display plate 74 each have a ring shape along the circumference of the bezel 75. FIG. 6A is a plan view showing the bezel of the wrist device according to the first embodiment.

In contrast, FIG. 6B shows a modified example of the bezel 75. FIG. 6B is a plan view showing the modified example of the bezel. As shown in FIG. 6B, in a bezel 75a according to the modified example, the bezel display plate 74 placed on the front side of the bezel main body portion 73 has a two-piece structure including a first bezel display plate 74b and a second bezel display plate 74c separated from each other. Here, the bezel main body portion 73 has a ring shape along the circumference of the bezel 75a similarly to the first embodiment. The first bezel display plate 74b and the second bezel display plate 74c according to the modified example are formed by separating portions from the ring along the circumference, similar to the first embodiment, and the bezel recessed portion 78 of the bezel main body portion 73 is exposed in the separated portions (regions) in the plan view. Also in the bezel 75a according to the modified example as described above, the holding of the windshield plate 71 (see FIG. 4) and the formation of the bezel display portion 76 (see FIG. 5A) as the display mark can be performed similarly to the bezel 75 of the first embodiment.

The parting plate 72 as the third member is provided between the display unit 70 provided directly below the windshield plate 71 and the windshield plate 71 at the outer edge portion of the windshield plate 71. Since the parting plate 72 is disposed between the windshield plate 71 and the display unit 70 each configured of a breakable material (brittle material), it is preferable that the parting plate 72 has the function of buffering an external impact or the like. Moreover, it is preferable from the viewpoint of a display function or designability that the parting plate 72 has a light transmitting property.

In order to respond to this, the parting plate 72 has a ring shape along the outer edge of the windshield plate 71 and is configured of a material having a longitudinal modulus of elasticity and a shear modulus of elasticity that are smaller than those of the windshield plate 71 and the display unit 70. It is desirable to use an ultraviolet-curable transparent resin material (member made of a resin) such as, for example, urethane acrylate, acrylic resin acrylate, or epoxy acrylate for the parting plate 72, similarly to the bezel display plate 74 of the bezel 75 described above.

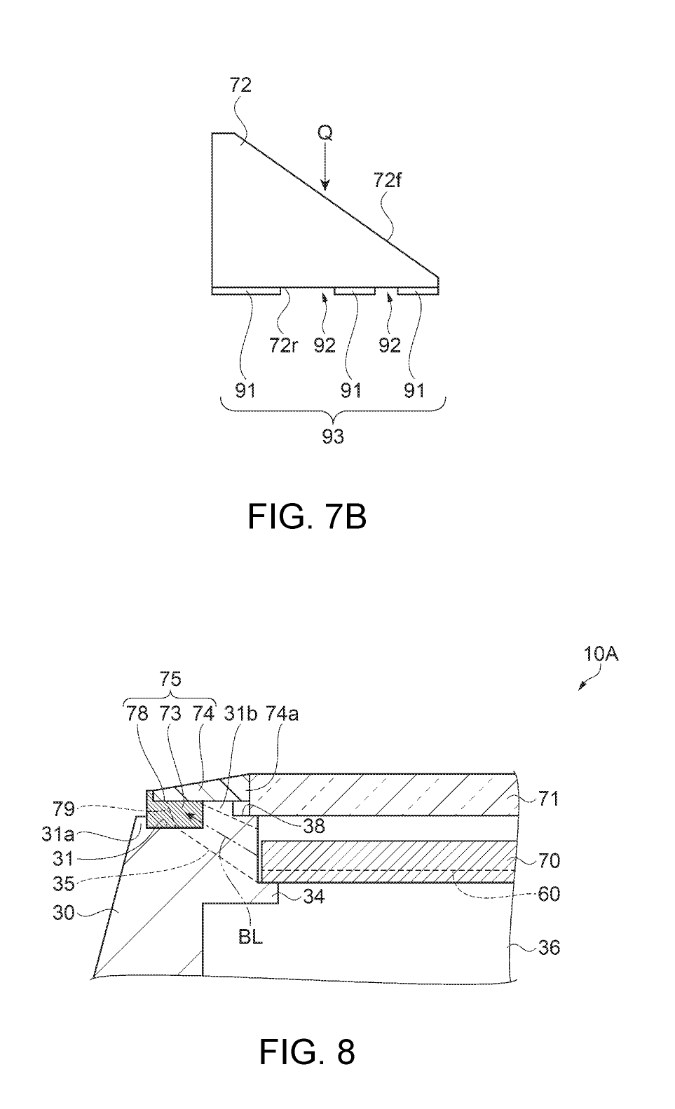

The parting plate 72 may have a cross-sectional shape in which a front surface 72f is a slope inclined with respect to a back surface 72r as shown in FIG. 7B. Alternatively, although not shown in the drawing, the parting plate 72 may have a quadrilateral cross-sectional shape in which the front surface 72f and the back surface 72r are parallel to each other.

A glass material is generally used as a substrate for each of the windshield plate 71 and the display unit 70. The longitudinal modulus of elasticity (Young's modulus E) of the glass material is approximately from 70 to 80 (GPa), and the Poisson's ratio v thereof is 0.17. That is, G=20 to 24 (GPa) is obtained from Equation (1) (G=[E/{2(1+v)}]) for the shear modulus of elasticity (rigidity modulus G) of the glass material. Moreover, the longitudinal modulus of elasticity (Young's modulus E) of the parting plate 72 formed of the cured resin material described above, for example urethane acrylate, is approximately 0.8 (GPa), and the shear modulus of elasticity (rigidity modulus G) thereof is G=0.30 (GPa), as described above. Moreover, when, for example, acrylic resin acrylate is used, the longitudinal modulus of elasticity (Young's modulus E) thereof is approximately 3.2 (GPa) and the shear modulus of elasticity (rigidity modulus G) thereof is G=1.19 (GPa). As described above, the relation in which the longitudinal modulus of elasticity (Young's modulus E) and the shear modulus of elasticity (rigidity modulus G) of the parting plate 72 as the third member are smaller than the longitudinal modulus of elasticity (Young's modulus E) and the shear modulus of elasticity (rigidity modulus G) of the windshield plate 71 and the display unit 70 is sufficiently satisfied.

By employing the parting plate 72 made of a resin as described above, the formation of the parting plate 72 can be performed by molding and curing using, for example, ultraviolet rays or the like. Therefore, the molding of the parting plate 72 can be easily performed, and it is possible to easily respond to the diversification of designs.

Moreover, by disposing the parting plate 72 as the third member having a longitudinal modulus of elasticity and a shear modulus of elasticity that are smaller than those of the windshield plate 71 and the display unit 70 between the windshield plate 71 on the outer edge side and the display unit 70 as described above, a stress occurring between the windshield plate 71 and the display unit 70 is attenuated (buffered) due to viscoelastic loss caused by distorting the parting plate 72, and thus it is possible to suppress damage caused by the stress of the windshield plate 71 and the display unit 70.

Here, a display of the parting plate 72 will be described with reference to FIGS. 7A and 7B. FIG. 7A shows a display example of the parting plate of the wrist device according to the first embodiment, is a diagram of a portion of the parting plate as viewed from the front side, and is a diagram (partial diagram) as viewed from Q in FIG. 7B. FIG. 7B is a cross-sectional view taken along line C-C in FIG. 7A, showing the parting plate.

As shown in FIGS. 7A and 7B, the functional mark 77 as a display mark is provided on the back surface 72r, which is a surface of the parting plate 72 on the display unit 70 side. The functional mark 77 can include, for example, a character 77a, a symbol (pictogram) 77b, and a scale (not shown). It is sufficient that the functional mark 77 is provided with at least one of the character 77a, the symbol (pictogram) 77b, and the scale (not shown). Moreover, a color tone may be changed or a pattern may be formed in the functional mark 77. Since the parting plate 72 is made of the resin having a light transmissive property as described above, the functional mark 77 can be visually recognized from the front surface 72f side (the windshield plate 71 side) even when the functional mark 77 is provided on the back surface 72r side.

The functional mark 77 can be configured of a display pattern 93 representing the character 77a or the symbol 77b formed using, for example, a back side printing (drawing) method or the like of a screen printing device, an inkjet printer, or the like. The functional mark 77 (the display pattern 93) can also be formed using an etching method. The display pattern 93 includes the light shielding portion 91 or the translucent portion (not shown) formed of, for example, ink or the like and the light transmissive portion 92 where the light shielding portion 91 or the translucent portion (not shown) is not formed. A pattern or color design can be expressed in the light shielding portion 91 or the translucent portion by changing the color or color tone of ink.

The parting plate 72 is provided between the display unit 70 and the outer edge portion of the windshield plate 71. The display unit 70 at the position overlapping the parting plate 72 in a plan view has a light transmissive property. With this configuration, the light emitted from the light source 60 of the display unit 70 and transmitted through the display unit 70 can be radiated to the parting plate 72. The parting plate 72 is made of the resin having a light transmissive property; therefore, when the light transmitted through the display unit 70 is radiated to the parting plate 72, the light passes through the light transmissive portion 92 or the translucent portion (not shown). Moreover, the radiated light is blocked at the portion of the light shielding portion 91.

Hence, the passing light can be visually recognized only in the portion of the light transmissive portion 92 or the translucent portion (not shown) as viewed from the windshield plate 71 side, and thus the contrast between the light transmissive portion 92 or the translucent portion and the light shielding portion 91 is brought out. The translucent portion (not shown) has a small amount of transmitted light compared to the light transmissive portion 92, and therefore glows slightly darker than the light transmissive portion 92. Moreover, since the display mark configured of the light transmissive portion 92 or the translucent portion (not shown) glows brightly with the light of the light source 60, the display mark can be visually recognized even in a dark state. As described above, the visibility of the display mark in the dark can be improved. Moreover, an improvement in designability such as, for example, changing the color or color tone can also be achieved.

In the display pattern 93, the portion of the character 77a or the symbol 77b can be the light transmissive portion 92 or the light shielding portion 91. That is, the character 77a or the symbol 77b glows when the character 77a or the symbol 77b is the light transmissive portion 92; while portions other than the character 77a or the symbol 77b glow when the character 77a or the symbol 77b is the light shielding portion 91.

According to the wrist device 1 according to the first embodiment of the portable (wearable) electronic device described above, the bezel 75 constituting the device main body 10 includes the bezel main body portion 73 as the first member and the bezel display plate 74 as the second member having a longitudinal modulus of elasticity and a shear modulus of elasticity that are smaller than those of the bezel main body portion 73. In addition, the bezel display plate 74 and the windshield plate 71 abut on each other, whereby the windshield plate 71 is held to the case (the top case 30). With this configuration, the impact transmitted from the case (the top case 30) side to the windshield plate 71 through the bezel 75 is attenuated (buffered) due to viscoelastic loss caused by distorting the bezel display plate 74 disposed between the windshield plate 71 and the case, so that it is possible to suppress damage that may be caused to the windshield plate 71. Moreover, the strength (rigidity) of the bezel 75 can be secured with the bezel main body portion 73 constituting the bezel 75, so that it is possible to reliably hold the windshield plate 71 to the case (the top case 30) while buffering the impact.

Moreover, the bezel display portion 76 as a display mark is provided by back side printing on the back surface 74r, which is the surface of the bezel display plate 74 on the bezel main body portion 73 side (the top case 30 side). The bezel display portion 76 is provided by back side printing as described above. Therefore, even if the exposed front surface 74f of the bezel 75 (the bezel display plate 74), which is likely to hit or rub against an external site and thus is often scratched, suffers damage such as a scratch or a hollow when the wrist device is worn by the user, the disappearance or falling off of the display mark can be prevented.

Moreover, the light BL emitted from the light source 60 can be radiated to the bezel display plate 74 through the light guide hole 35 provided on the outer edge side of the top case 30 and the light guide hole 79 provided in the bezel main body portion 73. Since the bezel display plate 74 and the parting plate 72 are made of the resin having a light transmissive property, the display marks formed on the bezel display plate 74 and the parting plate 72 can be caused to brightly glow with the radiated light BL. With this configuration, the display mark can be visually recognized during the use of the wrist device even in a dark state. Moreover, it is possible to apply an attractive display design or expand display design variations by causing the display mark to brightly glow.

### Second Embodiment

Next, the configuration of a wrist device according to a second embodiment of the portable (wearable) electronic device according to the invention will be described with reference to FIG. 8. FIG. 8 is a partial cross-sectional view showing a device main body of the wrist device according to the second embodiment. In the following description, configurations similar to those of the first embodiment described above are denoted by the same reference numerals and signs, and the description of the configurations may be omitted.

As shown in FIG. 8, compared to the device main body 10 of the first embodiment described above, the device main body 10A of the wrist device according to the second embodiment of the portable (wearable) electronic device differs from the device main body 10 in that the parting plate 72 having a ring shape provided on the front side of the display unit 70 in the device main body 10 of the first embodiment shown in FIG. 4 is not placed. Other configurations of the device main body 10A are similar to those of the device main body 10.

As shown in FIG. 8, the display unit 70 is placed on the projecting portion 34 projecting to the inside of the top case 30 in the device main body 10A. The light source 60 including the function as the backlight of the display unit 70 is disposed on the back side of the display unit 70.

For example, position information, exercise information such as the amount of movement or the amount of exercise, biological information such as a pulse rate, or the time-of-day information such as the current time is displayed according to various detection modes on the liquid crystal display (LCD) constituting the display unit 70. The user can view (visually recognize) this display through the windshield plate 71.

Moreover, the device main body 10A includes the recessed portion 31 having an annular shape located on the outer edge side of the top case 30 and opened toward the front side. The wall portion is configured on the outer circumferential side and the inner circumferential side of the recessed portion 31. The wall portion includes the first wall portion 31a on the outer circumferential side and the second wall portion 31b on the inner circumferential side. The bezel main body portion 73 (the bezel 75) as the first member is inserted into and fixed to the recessed portion 31. The light guide hole 35 penetrating the top case 30 from the position facing the display unit 70 or the light source 60 to the surface including the recessed portion 31 as the bezel main body portion 73 side is provided on the outer edge side of the top case 30.

The bezel recessed portion 78 including the wall portion on the outer circumferential side is provided on the front side of the bezel main body portion 73. The bezel display plate 74 as the second member is placed on the bezel recessed portion 78. The bezel main body portion 73 is provided with the light guide hole 79 penetrating the bezel main body portion 73 from the position facing the light guide hole 35 provided on the outer edge side of the top case 30 to the bezel recessed portion 78. The light BL emitted from the light source 60 including the function as the backlight of the display unit 70 can be radiated to the bezel display plate 74 through the light guide hole 35 provided on the outer edge side of the top case 30 and the light guide hole 79 provided in the bezel main body portion 73.

The bezel display plate 74 includes the eaves portion 74a protruding from the bezel main body portion 73 to the windshield plate 71 side and is fixed to the bezel main body portion 73. The eaves portion 74a of the bezel display plate 74 may abut on the top of the second wall portion 31b on the inner circumferential side of the top case 30. The bezel display plate 74 is configured of the material having elasticity with a small longitudinal modulus of elasticity (Young's modulus E) and a small shear modulus of elasticity (rigidity modulus G) as described in the first embodiment described above. However, sagging of the eaves portion 74a due to gravity can be prevented because the eaves portion 74a of the bezel display plate 74 abuts on the top of the second wall portion 31b on the inner circumferential side of the top case 30 described above, in addition to the bezel main body portion 73.

The windshield plate 71 is disposed on the inner circumferential surface side of the eaves portion 74a of the bezel display plate 74 protruding from the bezel main body portion 73. The windshield plate 71 abuts on the inner circumferential surface of the eaves portion 74a of the bezel display plate 74, and the outer edge portion of the windshield plate 71 on the back surface side is placed on a step portion 38 provided on the top case 30 on the side (the windshield plate 71 side) opposite to the projecting portion 34.

Even when the windshield plate 71 is configured such that the windshield plate 71 is placed on the step portion 38 provided on the top case 30 and is also held to the device main body 10A (the top case 30) by the bezel display plate 74 of the bezel 75 as described above, the windshield plate 71 can be held so as not to fall off from the device main body 10A (the top case 30). Also in such a configuration, the bezel display plate 74 having a longitudinal modulus of elasticity and a shear modulus of elasticity that are smaller than those of the bezel main body portion 73 abuts on the windshield plate 71 in the same manner as described above. With this configuration, the impact transmitted from the case (the top case 30) side to the windshield plate 71 through the bezel 75 is attenuated (buffered) due to viscoelastic loss caused by distorting the bezel display plate 74 disposed between the windshield plate 71 and the case, so that it is possible to suppress damage that may be caused to the windshield plate 71. Moreover, the strength (rigidity) of the bezel 75 can be secured with the bezel main body portion 73 constituting the bezel 75, so that it is possible to reliably hold the windshield plate 71 to the case (the top case 30) while buffering the impact.

### Third Embodiment

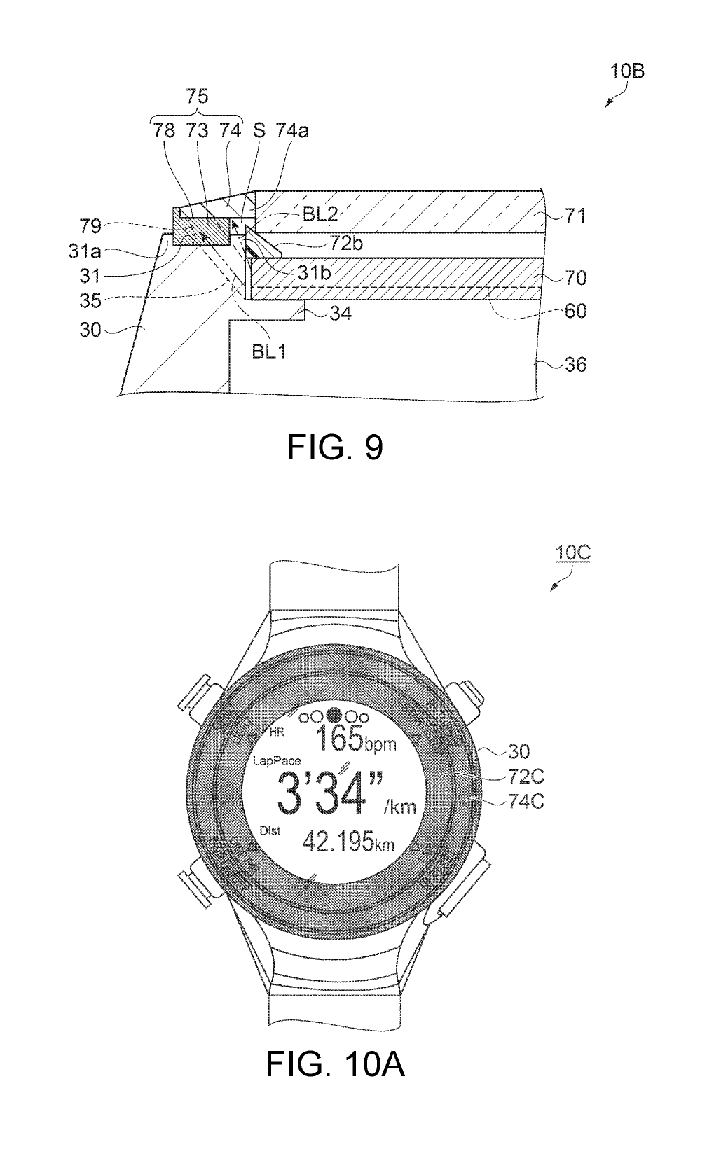

Next, the configuration of a wrist device according to a third embodiment of the portable (wearable) electronic device according to the invention will be described with reference to FIG. 9. FIG. 9 is a partial cross-sectional view showing a device main body of the wrist device according to the third embodiment. In the following description, configurations similar to those of the first embodiment described above are denoted by the same reference numerals and signs, and the description of the configurations may be omitted.

As shown in FIG. 9, compared to the device main body 10 of the first embodiment described above, the device main body 10B of the wrist device according to the third embodiment of the portable (wearable) electronic device is provided with a space between the top of the second wall portion 31b on the inner circumferential side of the top case 30 and the eaves portion 74a of the bezel display plate 74 in the device main body 10 of the first embodiment shown in FIG. 4. That is, the device main body 10B differs from the device main body 10 in that the top of the second wall portion 31b on the inner circumferential side of the top case 30 does not abut on the eaves portion 74a of the bezel display plate 74. Other configurations of the device main body 10B are similar to those of the device main body 10.

As shown in FIG. 9, the display unit 70 is placed on the projecting portion 34 projecting to the inside of the top case 30 in the device main body 10B. The light source 60 including the function as the backlight of the display unit 70 is disposed on the back side of the display unit 70.

For example, position information, exercise information such as the amount of movement or the amount of exercise, biological information such as a pulse rate, or the time-of-day information such as the current time is displayed according to various detection modes on the liquid crystal display (LCD) constituting the display unit 70. The user can view (visually recognize) this display through the windshield plate 71.

Moreover, the device main body 10B includes the recessed portion 31 having an annular shape located on the outer edge side of the top case 30 and opened toward the front side. The wall portion is configured on the outer circumferential side and the inner circumferential side of the recessed portion 31. The wall portion includes the first wall portion 31a on the outer circumferential side and the second wall portion 31b on the inner circumferential side. The bezel main body portion 73 (the bezel 75) as the first member is inserted into and fixed to the recessed portion 31. The light guide hole 35 penetrating the top case 30 from the position facing the display unit 70 or the light source 60 to the surface including the recessed portion 31 as the bezel main body portion 73 side is provided on the outer edge side of the top case 30.

The bezel recessed portion 78 including the wall portion on the outer circumferential side is provided on the front side of the bezel main body portion 73. The bezel display plate 74 as the second member is placed on the bezel recessed portion 78. The bezel main body portion 73 is provided with the light guide hole 79 penetrating the bezel main body portion 73 from the position facing the light guide hole 35 provided on the outer edge side of the top case 30 to the bezel recessed portion 78. The light BL emitted from the light source 60 including the function as the backlight of the display unit 70 can be radiated to the bezel display plate 74 through the light guide hole 35 provided on the outer edge side of the top case 30 and the light guide hole 79 provided in the bezel main body portion 73.

The bezel display plate 74 includes the eaves portion 74a protruding from the bezel main body portion 73 to the windshield plate 71 side and is fixed to the bezel main body portion 73. The windshield plate 71 is arranged and disposed on the inner circumferential surface side of the eaves portion 74a of the bezel display plate 74 protruding from the bezel main body portion 73. The windshield plate 71 abuts on the inner circumferential surface of the eaves portion 74a of the bezel display plate 74, and the outer edge portion of the windshield plate 71 on the back surface side abuts on a parting plate 72b.

Moreover, in the embodiment, the top of the second wall portion 31b on the inner circumferential side of the top case 30 does not abut on the eaves portion 74a of the bezel display plate 74, and a space S is provided between the top of the second wall portion 31b on the inner circumferential side of the top case 30 and the eaves portion 74a of the bezel display plate 74. Since the space S is provided, light BL2 passing through the display unit 70 and the parting plate 72b both having a light transmitting property is radiated to the bezel display plate 74 through the space S, in addition to light BL1 passing through the light guide hole 35 and the light guide hole 79.

As described above, a large amount of light obtained by adding the light BL2 to the light BL1 is radiated to the bezel display plate 74. Therefore, the amount of transmitted light when the device main body 10B is viewed from the front side is increased, so that the display mark (light transmitting portion) such as a character or a symbol can be made brighter. With this configuration, the display mark can be displayed more clearly and effectively, and for example, a variable amount of color or color tone can be increased, so that an improvement in the functionality or designability of display can also be achieved.

### Applications of Display

Other display methods (display examples) can be applied to the display using the parting plate 72 or the bezel 75 (the bezel display plate 74) shown in FIGS. 2 and 4 described above. Hereinafter, applications of the display according to the parting plate 72 or the bezel 75 (the bezel display plate 74) will be described with reference to the drawings. In the following description, configurations similar to those of the embodiments described above are denoted by the same reference numerals and signs, and the description of the configurations is omitted.

### Application 1

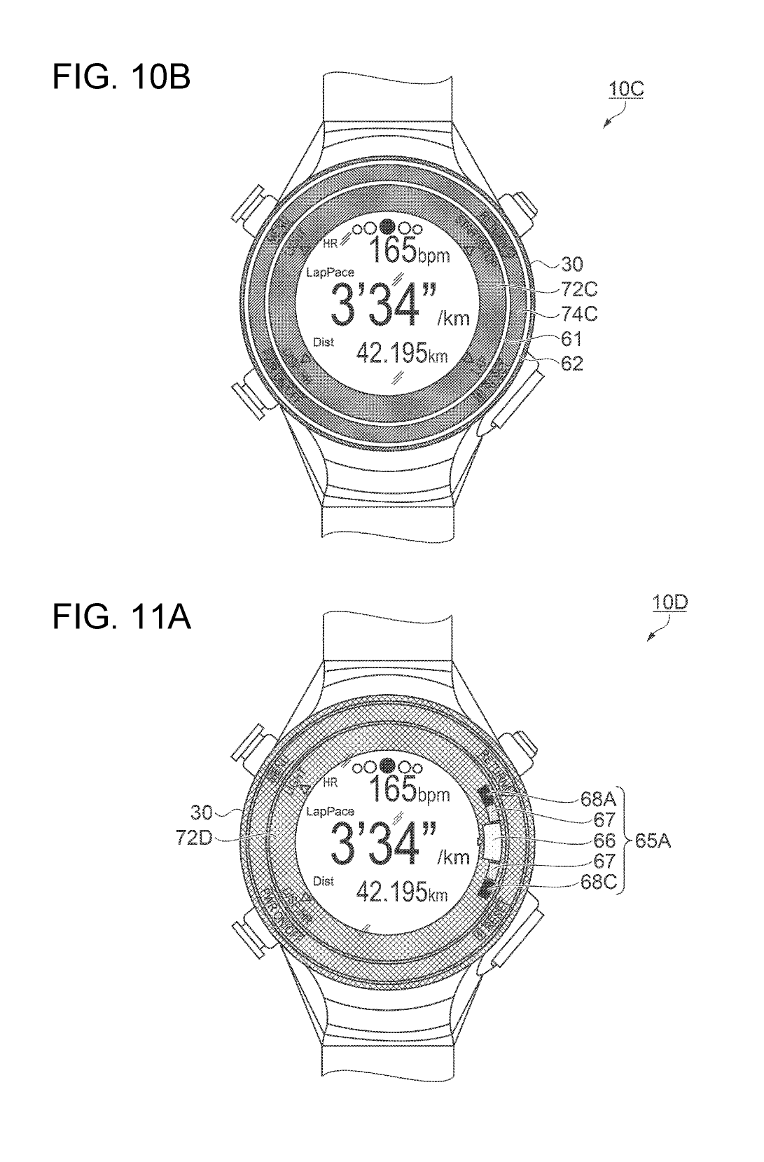

First, Application 1 of the display will be described with reference to FIGS. 10A and 10B. FIG. 10A is a plan view of a wrist device showing a display example of Application 1. FIG. 10B is a plan view showing a display state changed from the state of FIG. 10A in Application 1.

A device main body 10C to which the display example according to Application 1 is applied includes a parting plate 72C and a bezel display plate 74C constituting a bezel at the outer edge portion of the top case 30 on the front side as shown in FIGS. 10A and 10B. A parting ring 61 (see FIG. 10B) and a bezel ring 62 (see FIG. 10B) each of which is a light transmitting portion having a ring shape are provided respectively at the outer circumferential edge of the parting plate 72C and the outer circumferential edge of the bezel display plate 74C.

The parting ring 61 provided in the parting plate 72C and the bezel ring 62 provided in the bezel display plate 74C transmit the light emitted from the light source 60 (see FIG. 4), and any one or both of the parting ring 61 and the bezel ring 62 can be lit up or blinked. The color, color tone, or brightness of each of the parting ring 61 and the bezel ring 62 can be changed. In FIG. 10B, the lit-up state of the parting ring 61 and the bezel ring 62 is shown by the white lines.

Since the parting plate 72C and the bezel display plate 74C are lit up (transmit light) over the entire circumference thereof because the display marks (the parting ring 61 and the bezel ring 62) each having a ring shape are included as described above, the display marks of the parting plate 72C and the bezel display plate 74C are visually recognized easily. Moreover, it is possible to apply an attractive display design such as combining lighting-up of the display marks, for example, alternately lighting up the two display marks (the parting ring 61 and the bezel ring 62) having a ring shape, or blinking the display mark at an event.

Although the configuration in which the parting ring 61 and the bezel ring 62 each of which is the light transmitting portion having a ring shape are provided at the outer circumferential edge of the parting plate 72C and the outer circumferential edge of the bezel display plate 74C has been described in the example shown above, the parting ring 61 and the bezel ring 62 are not limited to this configuration. The parting ring 61 and the bezel ring 62 may be configured such that the parting ring 61 and the bezel ring 62 are provided at the middle portion between the outer circumferential edge and the inner circumferential edge of the parting plate 72C and the middle portion between the outer circumferential edge and the inner circumferential edge of the bezel display plate 74C, or that the parting ring 61 and the bezel ring 62 are provided at the inner circumferential edge of the parting plate 72C and the inner circumferential edge of the bezel display plate 74C.

### Application 2

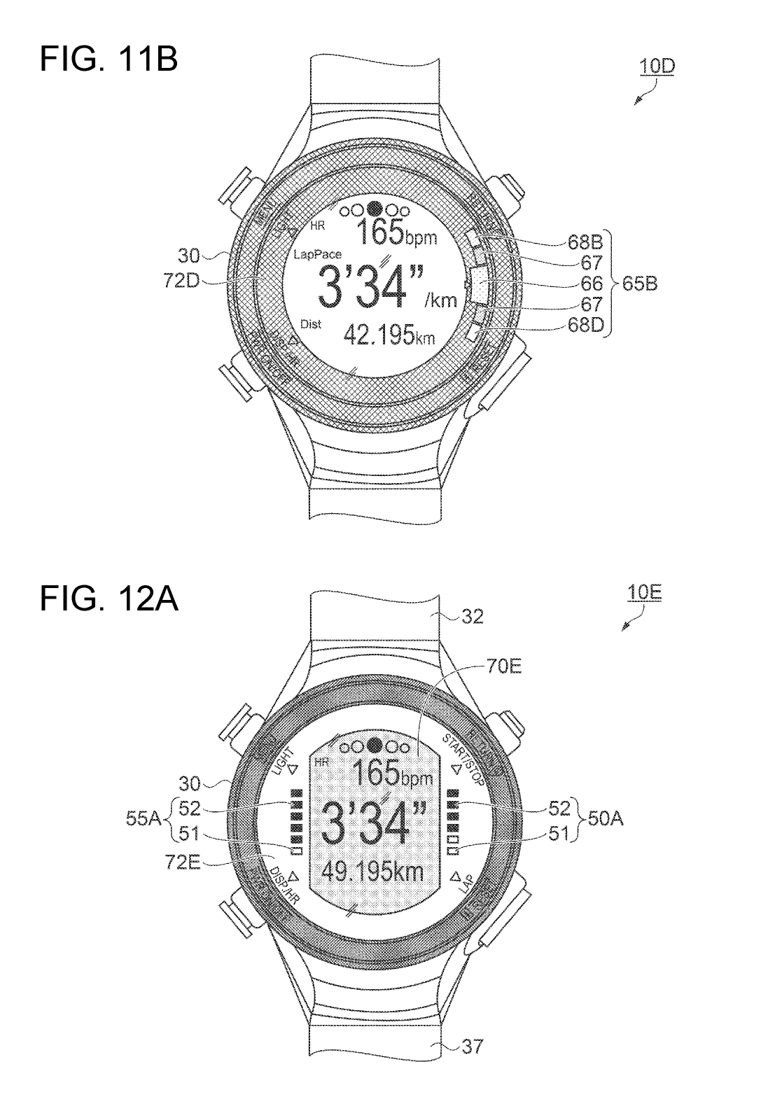

Next, Application 2 of the display will be described with reference to FIGS. 11A and 11B. FIG. 11A is a plan view of a wrist device showing a display example of Application 2. FIG. 11B is a plan view showing a display state of Application 2 changed from the state of FIG. 11A.

A device main body 10D to which the display example according to Application 2 is applied includes a parting plate 72D on the front side of the top case 30 as shown in FIG. 11A. The parting plate 72D is provided with an indicator 65A as a display mark including a central light emitting portion 66, first light emitting portions 67 respectively disposed on both sides of the central light emitting portion 66, and second light emitting portions 68A and 68C respectively disposed on the sides of the first light emitting portions 67 as shown in FIG. 11A. The display example of FIG. 11A shows the state where the central light emitting portion 66 and the first light emitting portions 67 on both sides thereof are lit up.

The indicator 65A can show, for example, the magnitude of motion intensity (level) or the magnitude of detected state level by means of the lit-up state thereof. FIG. 11B shows an indicator 65B whose lit-up state is changed from the state of FIG. 11A. Specifically, the second light emitting portions 68A and 68C, which are not lit up in FIG. 11A, are turned into the lit-up state (white-based display) shown by second light emitting portions 68B and 68D in the example shown in FIG. 11B.

The central light emitting portion 66, the first light emitting portions 67, and the second light emitting portions 68A and 68C, which constitute the indicator 65A, transmit the light emitted from the light source 60 (see FIG. 4), and any one or both of them can be lit up or blinked. The color, color tone, brightness, or the like of each of the central light emitting portion 66, the first light emitting portions 67, and the second light emitting portions 68A and 68C can be made different from each other and can be turned into the same state on a portion-by-portion basis.

By providing the indicator 65A, the magnitude of motion intensity (level) or the magnitude of detected level can be shown. Moreover, it is possible to realize various lighting-up specifications such as alternately lighting up the central light emitting portion 66, the first light emitting portions 67, and the second light emitting portions 68A and 68C, and it is possible to further expand the diversification of display designs or display lighting-up variations.

### Application 3

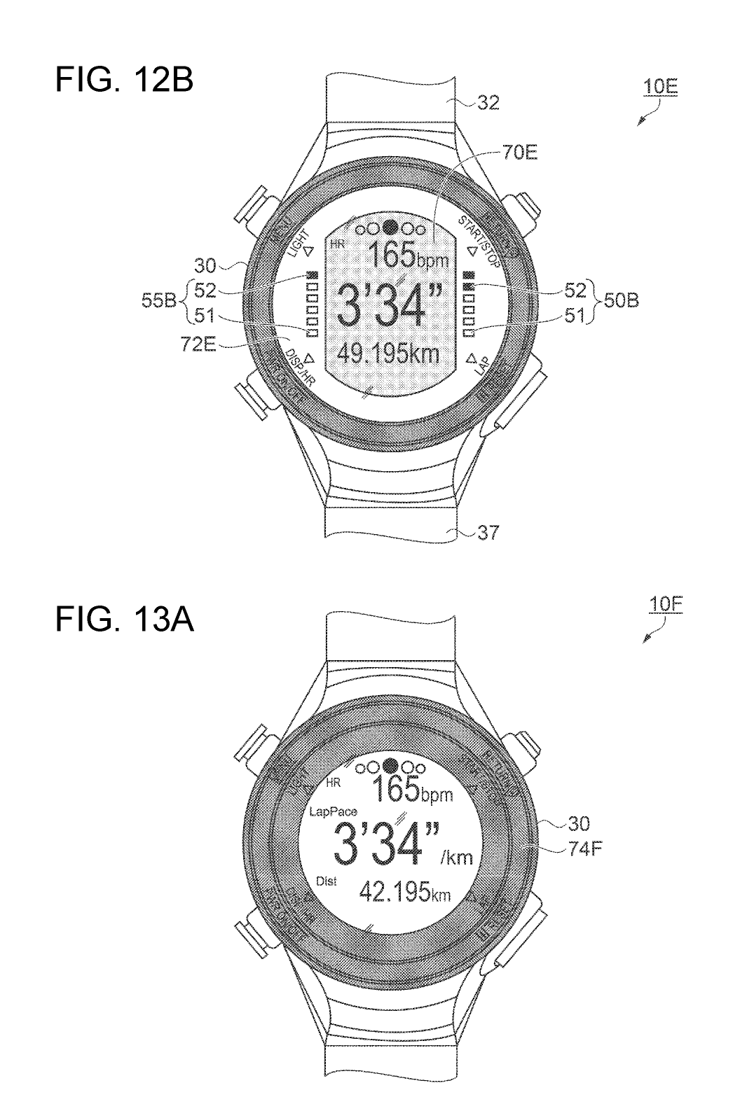

Next, Application 3 of the display will be described with reference to FIGS. 12A and 12B. FIG. 12A is a plan view of a wrist device showing a display example of Application 3. FIG. 12B is a plan view showing a display state of Application 3 changed from the state of FIG. 12A.

A device main body 10E to which the display example according to Application 3 is applied includes a parting plate 72E on the front side of the top case 30 as shown in FIG. 12A. The parting plate 72E is provided with indicators (a first indicator 50A and a second indicator 55A) on both sides of a display unit 70E interposed therebetween in a direction orthogonal to the arrangement direction of the first belt portion 32 and the second belt portion 37 as shown in FIG. 12A.

The first indicator 50A and the second indicator 55A each include six light emitting portions. The light emitting portions include a light emitting portion 51 showing a light emitting state (white display in the example) and a light emitting portion 52 showing a non-light emitting state (black display in the example). Specifically, in the example as shown in FIG. 12A, the first indicator 50A includes two light emitting portions 51 in the light emitting state and four light emitting portions 52 in the non-light emitting state, and the second indicator 55A includes one light emitting portion 51 in the light emitting state and five light emitting portions 52 in the non-light emitting state.

The first indicator 50A and the second indicator 55A can show, for example, the magnitude of motion intensity (level) or the magnitude of detected state level by means of the lit-up state thereof similarly to Application 2 described above. FIG. 12B shows a second indicator 55B whose lit-up state is changed from the state of FIG. 12A. Specifically, in FIG. 12B, the number of light emitting portions 51 in the light emitting state increases by two to four in the first indicator 50B, and the number of light emitting portions 51 in the light emitting state increases by four to five in the second indicator 55B.

The light emitting portions 51 and 52 constituting the first indicator 50B and the second indicator 55B can glow by transmitting the light emitted from the light source 60 (see FIG. 4). The first indicator 50B and the second indicator 55B can have different display functions. In addition, the light emitting portions 51 and 52 of each of the first indicator 50B and the second indicator 55B can be lit up, blinked, or turned off. The color, color tone, brightness, or the like of each of the light emitting portions 51 and 52 can be made different from each other and can be turned into the same state on a portion-by-portion basis.

Since the indicators (the first indicator 50A and the second indicator 55A) are provided on both sides of the display unit 70E interposed therebetween in the device main body 10E according to Application 3 as described above, level displays corresponding to various states such as, for example, the magnitude of motion intensity (level) or the magnitude of detected level can be simultaneously displayed. Moreover, it is possible to realize various lighting-up specifications such as alternately lighting up the light emitting portions 51 and 52, and it is possible to further expand the diversification of display designs or display lighting-up variations.

### Application 4

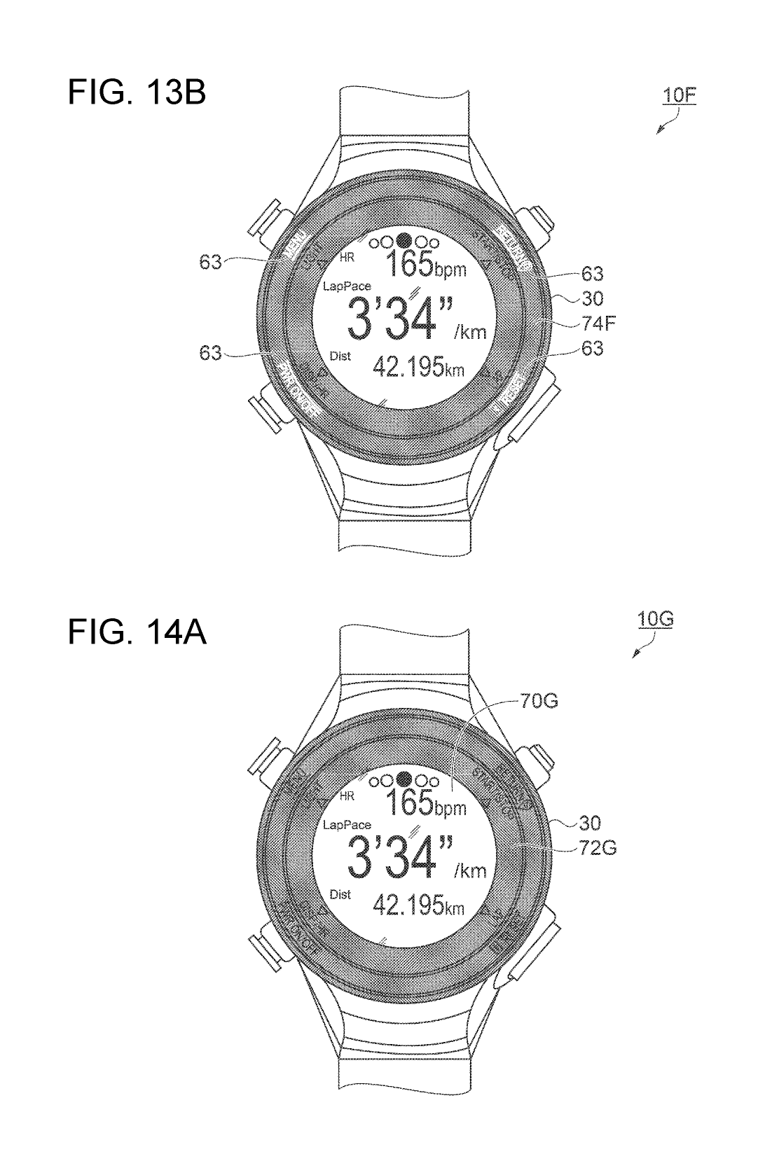

Next, Application 4 of the display will be described with reference to FIGS. 13A and 13B. FIG. 13A is a plan view of a wrist device showing a display example of Application 4. FIG. 13B is a plan view showing a display state changed from the state of FIG. 13A in Application 4.

A device main body 10F to which the display example according to Application 4 is applied includes a bezel display plate 74F constituting a bezel at the outer edge portion of the top case 30 on the front side as shown in FIGS. 13A and 13B. The bezel display plate 74F is provided with bezel display portions 63, in each of which a character or symbol is disposed as a display mark, at four places of the bezel display plate 74F having a ring shape.

The character or symbol constituting the bezel display portion 63 is a light transmitting portion and transmits the light emitted from the light source 60 (see FIG. 4). Any one or two to four of the bezel display portions 63 at the four places can be lit up or blinked. The color, color tone, or brightness of each of the characters or symbols constituting the bezel display portions 63 can be changed. FIG. 13B shows the state where the four bezel display portions 63 are lit up with white characters or white symbols.

Since the character or symbol constituting the bezel display portion 63 is provided on the bezel display plate 74F and lit up (transmits light), the display mark of the bezel display plate 74F is visually recognized easily. Moreover, it is possible to apply an attractive display design such as combining lighting-up of the display marks, for example, alternately lighting up the plurality of display marks (the bezel display portions 63) of the bezel display plate 74F, or blinking the display mark at an event, or to expand display design variations.

### Application 5

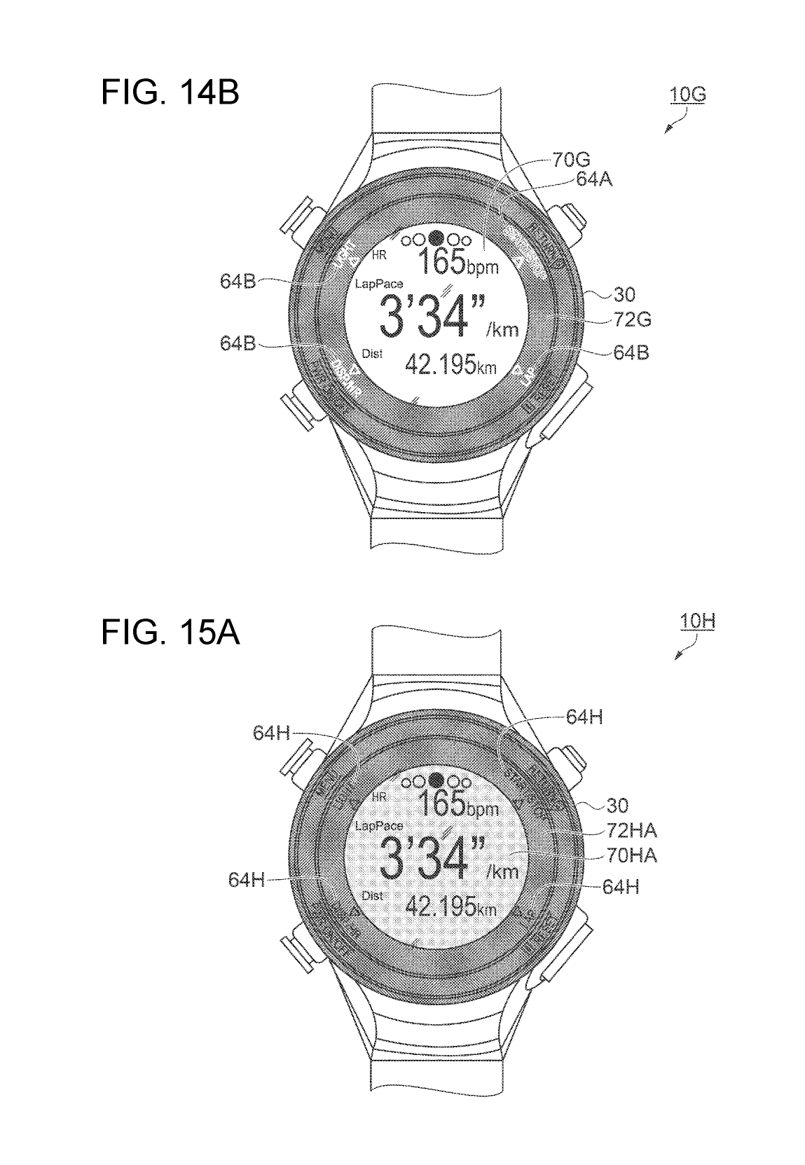

Next, Application 5 of the display will be described with reference to FIGS. 14A and 14B. FIG. 14A is a plan view of a wrist device showing a display example of Application 5. FIG. 14B is a plan view showing a display state changed from the state of FIG. 14A in Application 5.

A device main body 10G to which the display example according to Application 5 is applied includes a parting plate 72G having a ring shape at the outer edge portion of a display unit 70G on the front side of the top case 30 as shown in FIGS. 14A and 14B. The parting plate 72G is provided with functional marks 64A and 64B, in each of which a character or symbol is disposed as a display mark, at four places.

The characters or symbols constituting the functional marks 64A and 64B are light transmitting portions and transmit the light emitted from the light source 60 (see FIG. 4). Any one or two to four of the functional marks 64A and 64B at the four places can be lit up or blinked. The color, color tone, or brightness of each of the characters or symbols constituting the functional marks 64A and 64B can be changed. FIG. 14B shows the functional mark 64A in the non-lit-up state and the three functional marks 64B in the lit-up state (glowing state), in which the lit-up state is shown with white characters or white symbols and the non-lit-up state is shown with black characters or black symbols.

Since the functional marks 64A and 64B are configured such that the characters or symbols constituting the functional marks 64A and 64B are provided on the parting plate 72G and lit up (transmit light), the display mark of the parting plate 72G is visually recognized easily. Moreover, it is possible to apply an attractive display design such as combining lighting-up of the display marks, for example, alternately lighting up the plurality of display marks (the functional marks 64A and 64B) of the parting plate 72G, or blinking the display mark at an event, or to further expand display design variations.

### Application 6

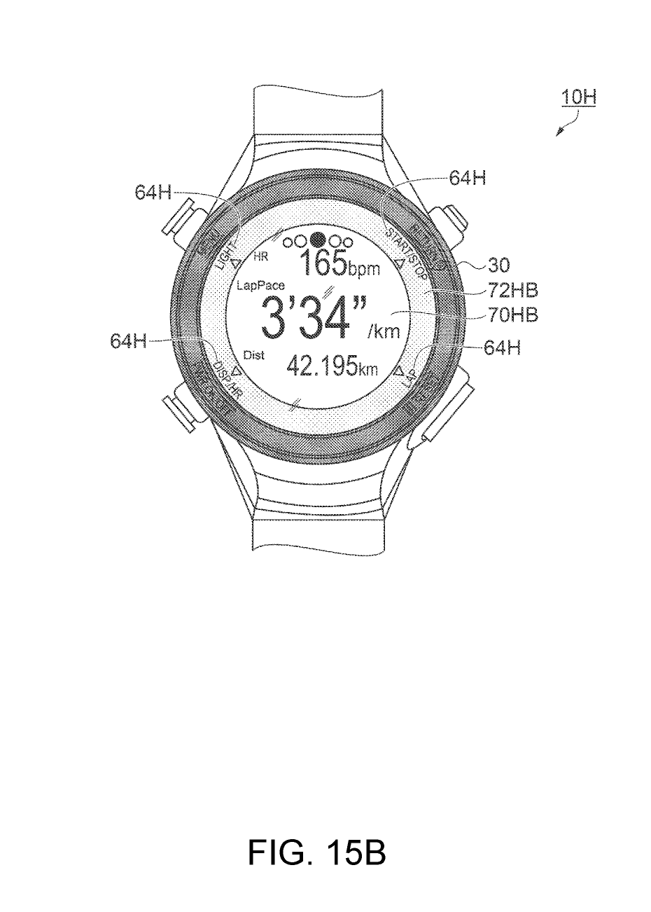

Next, Application 6 of the display will be described with reference to FIGS. 15A and 15B. FIG. 15A is a plan view of a wrist device showing a display example of Application 6. FIG. 15B is a plan view showing a display state changed from the state of FIG. 15A in Application 6.

A device main body 10H to which the display example according to Application 6 is applied includes a parting plate 72HA having a ring shape at the outer edge portion of a display unit 70HA located on the front side of the top case 30 as shown in FIG. 15A. The parting plate 72HA is provided with functional marks 64H, in each of which a character or symbol is disposed as a display mark, at four places. A reduced illuminance state is applied to each of the display unit 70HA and the parting plate 72HA. Power consumption can be suppressed by the use of the display unit 70HA and the parting plate 72HA in the reduced illuminance state as described above.

FIG. 15B shows a display unit 70HB and a parting plate 72HB in a bright state with increased illuminance. When it becomes necessary to further improve visibility, the illuminance of at least one of the display unit 70HB and the parting plate 72HB can be increased. The functional mark 64H is further improved in visibility because the parting plate 72HB is brightened.

The parting plate 72HA is a light transmitting portion having a light transmissive property except for the functional mark 64H. The parting plate 72HA transmits the light emitted from the light source 60 (see FIG. 4) and thus can be turned to the parting plate 72HB in the glowing state. Hence, the parting plate 72HA can be brightened, darkened, or blinked. The color, color tone, or brightness of the parting plate 72HA can be changed. Also the display unit 70HA can be brightened, darkened, or blinked.

Since the whole of the parting plate 72HA glows (the parting plate 72HB) in the configuration described above, the visibility of the display mark can be improved even when the wrist device is used under a dark environment. Moreover, the color or color tone of the parting plate 72HA can be arbitrarily set, and thus it is possible to improve designability or expand display design variations.

Although the wrist device worn on the wrist of the user has been illustrated as the portable electronic device worn on a given site of the user (wearer) in the above description, the following wearing examples can be illustrated. The portable electronic device may be configured, for example, like a necklace hanging around the neck, configured to be worn on the torso, ankle, or the like, or configured to be held in a pocket or bag by the user like a portable information terminal.

Although the description has been made using the GPS (Global Positioning System) as a satellite positioning system, other GNSSs (Global Navigation Satellite Systems) may be used. For example, one of or two or more of satellite positioning systems such as EGNOS (European Geostationary-Satellite Navigation Overlay Service), QZSS (Quasi Zenith Satellite System), GLONASS (GLObal NAvigation Satellite System), GALILEO, and BeiDou (BeiDou Navigation Satellite System) may be used. Moreover, SBAS (Satellite-based Augmentation System) such as WAAS (Wide Area Augmentation System) or EGNOS (European Geostationary-Satellite Navigation Overlay Service) may be used as at least one of the satellite positioning systems.

What is claimed is:

1. A portable electronic device comprising:
a case;
a ring-shaped bezel attached to the case and including:
a first member having a ring shape and front and back surfaces, the back surface of the first member fitted to the case, and
a second member composed of a material of lower hardness than the first member and supported by the front surface of the first member; and
a windshield plate supported by the second member.

2. The portable electronic device according to claim 1, wherein
a longitudinal modulus of elasticity of the second member is smaller than a longitudinal modulus of elasticity of the first member, or
a shear modulus of elasticity of the second member is smaller than a shear modulus of elasticity of the first member.

3. The portable electronic device according to claim 1, wherein the second member is made of a resin.

4. The portable electronic device according to claim 1, wherein the second member has a light transmissive property, a back surface facing the case, and a display mark on the back surface.

5. The portable electronic device according to claim 4, wherein the display mark includes at least one of a character, a symbol, a scale, and a pattern.

6. The portable electronic device according to claim 1, wherein the second member includes an eaves portion protruding beyond the first member in a radial direction of the first member to contact the windshield plate.

7. The portable electronic device according to claim 1, wherein
the case has a front side facing the back surface of the first member and including a recessed portion sized to accommodate at least a portion of the first member therein, and
the at least a portion of the first member is disposed in the recessed portion.

8. The portable electronic device according to claim 1, further comprising:
a display having front and back surfaces and supported by the case, the front surface of the display facing the windshield plate; and
a light source supported by the case and disposed behind the back surface of the display to irradiate the back surface of the display with light, wherein
the first member is provided with a light guide hole extending between the back surface and the front surface of the first member, and
the light emitted from the light source is transmitted to the second member through the light guide hole.

9. The portable electronic device according to claim 8, further comprising a ring-shaped third member abutting an outer edge of the windshield plate and disposed between the windshield plate and the display, wherein
a longitudinal modulus of elasticity of the third member is smaller than a longitudinal modulus of elasticity of the windshield plate and the display, or
a shear modulus of elasticity of the third member is smaller than a shear modulus of elasticity of the windshield plate and the display.

10. The portable electronic device according to claim 9, wherein the third member is made of a resin.

11. The portable electronic device according to claim 9, wherein
the windshield plate has a front surface, and
the third member includes the display mark visually recognizable from the front surface of the windshield plate.

12. The portable electronic device according to claim 10, wherein
the display includes an overlapping region that overlaps the third member in a plan view,
the overlapping region of the display and the third member have a light transmissive property, and
the light emitted from the light source irradiates the third member through the overlapping region.

13. The portable electronic device according to claim 1, wherein
a longitudinal modulus of elasticity of the second member is smaller than a longitudinal modulus of elasticity of the first member, and
a shear modulus of elasticity of the second member is smaller than a shear modulus of elasticity of the first member.

14. The portable electronic device according to claim 8, further comprising a ring-shaped third member abutting an outer edge of the windshield plate and disposed between the windshield plate and the display, wherein
a longitudinal modulus of elasticity of the third member is smaller than a longitudinal modulus of elasticity of the windshield plate and the display, and
a shear modulus of elasticity of the third member is smaller than a shear modulus of elasticity of the windshield plate and the display.

15. A ring-shaped bezel for holding a windshield plate of a case of a portable electronic device comprising:
a ring-shaped first member having front and back surfaces, the back surface of the first member fitted to the case, the front surface including a recessed portion; and
a ring-shaped second member composed of a material of lower hardness than the first member, disposed in the recessed portion of the first member, and holding the windshield plate.

16. The ring-shaped bezel according to claim 15, wherein
the recessed portion includes an outer-circumferential wall portion, and
one end of the second member abuts the outer-circumferential wall portion.

17. The ring-shaped bezel according to claim 15, wherein
a longitudinal modulus of elasticity of the second member is smaller than a longitudinal modulus of elasticity of the first member, or
a shear modulus of elasticity of the second member is smaller than a shear modulus of elasticity of the first member.

18. The ring-shaped bezel according to claim 15, wherein
a longitudinal modulus of elasticity of the second member is smaller than a longitudinal modulus of elasticity of the first member, and
a shear modulus of elasticity of the second member is smaller than a shear modulus of elasticity of the first member.

19. The ring-shaped bezel according to claim 15, wherein the second member is made of a resin.

20. The ring-shaped bezel according to claim 15, wherein the second member has a light transmissive property, a back surface facing the case, and a display mark on the back surface that includes at least one of a character, a symbol, a scale, and a pattern.

21. The ring-shaped bezel according to claim 15, wherein the second member includes an eaves portion protruding beyond the first member in a radial direction of the first member to contact the windshield plate.

22. The ring-shaped bezel according to claim 15, wherein
the first member is provided with a light guide hole extending between the back surface and the front surface thereof, and
light emitted from a light source disposed inside the case behind a display is transmitted to the second member through the light guide hole.

23. The portable electronic device according to claim 22, further comprising a ring-shaped third member abutting an outer edge of the windshield plate and disposed between the windshield plate and the display, wherein
a longitudinal modulus of elasticity of the third member is smaller than a longitudinal modulus of elasticity of the windshield plate and the display, or
a shear modulus of elasticity of the third member is smaller than a shear modulus of elasticity of the windshield plate and the display.

24. The portable electronic device according to claim 23, wherein the third member is made of a resin, has a light transmissive property, and includes a display mark visually recognizable from a front surface of the windshield plate.
